(19) United States
(12) Patent Application Publication
(10) Pub. No.: US 2026/0139880 A1
(43) Pub. Date: May 21, 2026

(54) SOLAR DRIVEN THERMOACOUSTIC REFRIGERATOR

(71) Applicant: Khalifa University of Science and Technology, Abu Dhabi (AE)

(72) Inventors: Isam Janajreh, Abu Dhabi (AE); Omar Al Mufti, Abu Dhabi (AE); Ussama Ali, Abu Dhabi (AE)

(21) Appl. No.: 18/954,899

(22) Filed: Nov. 21, 2024

(51) Int. Cl. F25B 23/00; F03G 7/00

(52) U.S. Cl. CPC F25B 23/00; F03G 7/002

(57) ABSTRACT

Techniques, methods, and systems are described for a device that includes a collector configured to collect energy, a waveguide, a thermoacoustic engine (TAE) within the waveguide. The TAE includes a first TAE heat exchanger configured to receive the energy from the collector and convert the energy into first thermal energy, a TAE regenerator configured to convert the first thermal energy into an acoustic wave. The device includes a thermoacoustic refrigerator (TAR) within the waveguide including a TAR regenerator configured to convert the acoustic wave into second thermal energy, and a TAR heat exchanger configured to direct the second thermal energy to a substance.

### FIELD

The present disclosure is directed to heat exchangers. More particularly, the present disclosure describes thermoacoustic refrigeration for district cooling.

### BACKGROUND

Currently, there is worldwide pressing need to transition away from fossil fuels and to enhance the efficiency of renewable energy sources. Emissions reduction and promoting cleaner energy production safeguard the environment from the alarming increasing carbon dioxide (CO₂) emissions and atmosphere pollution concentrations. Regarding cooling, the increasing refrigeration demand is a global warming contributor by way of greenhouse gas emissions with no signs of slowing down. District cooling is recently emerging, especially in the Gulf region, to offer centralized and efficient cooling. However, the current refrigeration methods are not environmentally friendly and rely heavily on conventional energy release methods such as fossil fuels. Thus, a refrigeration technology that can offset the refrigeration demand sustainably is needed.

### BRIEF SUMMARY

In some embodiments, a device includes a collector configured to collect energy, a waveguide, and a thermoacoustic engine (TAE) within the waveguide. The TAE includes a first TAE heat exchanger configured to receive the energy from the collector and convert the energy into first thermal energy, a TAE regenerator configured to convert the first thermal energy into an acoustic wave. The device also includes a thermoacoustic refrigerator (TAR) within the waveguide including a TAR regenerator configured to convert the acoustic wave into second thermal energy, and a TAR heat exchanger configured to direct the second thermal energy to a substance.

In some embodiments, the TAE regenerator and the TAR regenerator include a structural configuration selected from a group including one or more spirals, one or more concentric circles, one or more parallel substrates, a honeycomb configuration, a square mesh configuration, a triangular configuration, a repeating shape pattern, a pin array pattern, or combinations thereof.

In some embodiments, the TAE regenerator and the TAR regenerator include a material selected from a group comprising: a metal, an alloy, a ceramic, a composite, a polymer, an organic compound, a foam, or combinations thereof. In some examples, the TAE regenerator and the TAR regenerator may include different materials.

In some embodiments, the TAE may have a higher thermal conductivity than the TAR.

In some embodiments, the first TAE heat exchanger includes a first inlet configured to receive a first fluid, a first internal compartment configured to circulate the first fluid in proximity to the TAE regenerator to transfer heat between the first fluid and the TAE regenerator, and a first outlet configured to direct the first fluid out of the first TAE heat exchanger. In some examples, the first TAR heat exchanger may include a second inlet configured to receive a second fluid, a second internal compartment configured to circulate the second fluid in proximity to the TAR regenerator to transfer heat between the second fluid and the TAR regenerator, and a second outlet configured to direct the second fluid out of the first TAR heat exchanger. In some examples, the second fluid has a lower temperature than the first fluid.

In some embodiments, the device may include a receiver configured to receive the energy from the collector and the waveguide may include a first end coupled to the receiver and configured to receive the energy from the receiver and direct the energy to the first TAE heat exchanger such that the first end is closed and a second end distal from the collector, such that the second end includes an opening. In some examples, the device may include a buffer compartment connected to the second end and configured to permit thermal expansion or contraction of a fluid within the waveguide.

In some embodiments, the device may include an azimuth adjuster configured to control an azimuth angle of at least one of the collector, the waveguide, the TAE, or the TAR, or combinations thereof. In some examples, the device may include an elevation adjuster configured to control a tilt angle of at least one of: the collector, the waveguide, the TAE, or the TAR and a heliostat controller configured to control at least one of: the azimuth adjuster or the elevation adjuster to track a solar azimuth or elevation.

In some embodiments, a system includes a first thermoacoustic device that includes a collector configured to collect energy from an energy source, a waveguide configured to receive the energy from the collector, a thermoacoustic engine (TAE) within the waveguide configured to convert the energy into an acoustic wave, a thermoacoustic refrigerator (TAR) within the waveguide configured to convert the acoustic wave into thermal energy, and a fluid network including a conduit that has a fluid, wherein the fluid is configured to exchange the thermal energy with the TAR.

In some embodiments, the system may include a second thermoacoustic device coupled to the fluid network and configured to receive the fluid from the first thermoacoustic device at an inlet to a TAR heat exchanger of the second thermoacoustic device, wherein the second thermoacoustic device is in series with the first thermoacoustic device.

In some embodiments, the system may include a second thermoacoustic device coupled to the fluid network and configured to contribute a second fluid to the fluid from the first thermoacoustic device. In some examples the second thermoacoustic device may be in parallel with the first thermoacoustic device.

In some embodiments, the system may include a fluid reservoir coupled to the fluid network configured to store an amount of stored fluid, wherein the fluid reservoir is configured to supply the first thermoacoustic device with the fluid and store excess circulated fluid from the first thermoacoustic device.

In some embodiments, the system may include a waste fluid network coupled to the fluid network. In some examples, the waste fluid network is configured to direct one or more waste fluids to the first thermoacoustic device as an input fluid to the TAR.

In some embodiments, the waveguide may be a quarter wavelength standing wave waveguide.

In some embodiments, a method may include receiving, at a waveguide, energy, converting the energy into first thermal energy within the waveguide, converting the first thermal energy into an acoustic wave within the waveguide, converting the acoustic wave into second thermal energy within the waveguide, and directing the second thermal energy to a substance.

In some embodiments, the energy is converted into the first thermal energy and the first thermal energy is converted into the acoustic wave by a thermal acoustic engine (TAE), and wherein the acoustic wave is converted into the second thermal energy by a thermal acoustic refrigerator (TAR).

In some embodiments, the method may include generating a first temperature differential within the waveguide which at least partially overlaps the TAE, in response to generating the first temperature differential within the waveguide, generating a standing wave including the acoustic wave; and in response to generating the standing wave, generating a second temperature differential which at least partially overlaps the TAR, wherein a first end of the TAR is at a higher temperature than a second end of the TAR.

In some embodiments, the acoustic wave is a traveling wave. In some examples, the method may include directing the traveling wave towards one or more additional TARs and TAEs such that the additional TARs and TAEs are connected in series with the TAR and TAE.

In some embodiments, the method may include receiving waste thermal energy, and directing the waste thermal energy to the waveguide. In some examples, the first thermal energy includes the waste thermal energy.

In some embodiments, the energy includes solar energy. In some examples, the method may include receiving, by a parabolic reflector, the energy, wherein the energy is solar energy, focusing, by the parabolic reflector, the solar energy towards the waveguide, and converting the solar energy into the first thermal energy within the waveguide.

In some embodiments, the substance is a flowing fluid connected to one or more components arranged in a district for cooling the one or more components by circulating the flowing fluid within the district. In some examples, the method may include receiving, at the waveguide, at least a portion of the flowing fluid from the district at a first temperature, and lowering the first temperature of at least a portion of the flowing fluid to a second temperature.

In some embodiments, various technical features, aspects, and advantages of the present disclosure are readily appreciated from the following detailed description. The present disclosure should not be considered limiting, and one or more embodiments discussed herein may be combined in various non-limiting ways. Some or all embodiments herein may be modified without departing from the scope of the present disclosure. The detailed description and drawings may be illustrative of the present disclosure such that advantages of the disclosure will be demonstrated.

### BRIEF DESCRIPTION OF THE DRAWINGS

The foregoing aspects and many of the advantages of the present disclosure will become more readily appreciated as these advantages become better understood by reference to the following detailed description, when taken in conjunction with the accompanying drawings.

FIG. 1 is a simplified diagram of an example thermoacoustic device connected to a network, according to some embodiments.

FIG. 2 is a simplified diagram of an example solar thermoacoustic device, according to some embodiments.

FIG. 3 is a simplified diagram of an example traveling wave thermoacoustic device, according to some embodiments.

FIG. 4 depicts simplified cross-section diagrams of an example stack and a heat exchanger used in a thermoacoustic device, according to some embodiments.

FIG. 5 is a simplified diagram of example arrangements of thermoacoustic devices, according to some embodiments.

FIG. 6 is a simplified diagram of an example heat exchange network using thermoacoustic devices, according to some embodiments.

FIG. 7 is a simplified diagram of an example heat exchange network using solar thermoacoustic devices, according to some embodiments.

FIG. 8 is a simplified diagram of an example coefficient of performance (COP) and cooling power graph for a thermoacoustic device, according to some embodiments.

FIG. 9 is a simplified block diagram of an example process using a thermoacoustic device, according to some embodiments.

FIG. 10 is a simplified block diagram of an example system for thermoacoustic devices, according to some embodiments.

In the drawings, like reference numerals refer to like parts throughout the various views and embodiments unless otherwise specified. Not all instances of an element are necessarily labeled to improve clarity in the drawings where appropriate. The drawings are not necessarily to scale, emphasis instead being placed upon illustrating the principles being described.

### DETAILED DESCRIPTION

Embodiments are described below in the context of thermoacoustic cooling, and more particularly to solar thermoacoustic refrigerator used for cooling applications. While various examples herein discuss using solar energy, it should not be considered limiting, and any suitable energy source may be implemented in conjunction with the heat exchangers discussed herein.

Conventional refrigeration technology may convert electrical energy to perform heat transfer operations on working fluids to provide cooling to components such as buildings, infrastructure, etc. This process may produce substantial unwanted heat when used indoors as the components are cooled. In addition, this process is typically inefficient and uses an environmentally unfriendly coolant fluid that needs specialized technicians and personnel to handle and dispose of. On top of these deficiencies, conventional refrigeration technologies use compressors which are noisy, inefficient, and may not be readily available for replacement depending on the region they are used in. There is a growing demand for cleaner and greener technologies to provide cooling solutions. Refrigeration technology that can offset the refrigeration demand sustainably is growing in demand as the world becomes more dependent on energy. Converting solar energy to cooling can proceed indirectly from solar to electrical energy and then to cooling, or directly through the Peltier effect or other thermoacoustic methods. In regions such as gulf regions or tropics with abundant solar resources, a customer need for cooling makes these regions ideal for solar cooling applications.

This disclosure presents a reliable and scalable district cooling method based on thermoacoustic heating and cooling, integrated with clean solar energy, and has minimal number of moving parts. In one aspect, integration of thermoacoustic refrigeration into cooling systems is disclosed. Various configurations of multiple thermoacoustic refrigerators can be employed to satisfy a large cooling load. Each thermoacoustic refrigerator is driven by and connected to a thermoacoustic engine via a waveguide. The thermoacoustic engine uses heat to produce mechanical energy in the form of acoustic waves. The heat source is concentrated solar power like solar dish or heliostat (or wasted thermal heat from utility power or industrial smelting processes). The acoustic energy is then consumed by the thermoacoustic refrigerator to cool the water that passes through its cold heat exchanger. The chilled water is supplied to consumers before returning to the thermoacoustic refrigerators. A fluid at ambient conditions may be provided for a continuous operation of the thermoacoustic system. This may be air or water supplied from a reservoir or cooling towers. The system's moving parts are mainly pumps and energy source tracking system (e.g., solar tracking systems), while the thermoacoustic system itself need not contain any moving part, which emphasizes a sustainable and reliable operation suitable for district cooling scale.

Embodiments of the present disclosure offer several advantages over conventional cooling methods (e.g., vapor compression cycle). For instance, thermoacoustic refrigerators utilize green and inert gases (i.e., air, helium, or argon) instead of harmful refrigerants. Moreover, the whole process uses fewer moving parts. These moving parts are not in the thermoacoustic aspect of the system, which cases the process of maintaining such systems. Furthermore, the energy needed to run the process may be acquired partially or entirely from a renewable energy source instead of electricity that is typically produced using fossil fuels.

Moreover, it is important to note that the thermodynamic cycle of thermoacoustic refrigerators, particularly standing wave, bears similarities to the conventional vapor compression cycle. The compression and expansion processes occur through oscillating flow (acoustic waves) rather than utilizing a compressor and expansion valve. The roles of the ambient heat exchanger and cold heat exchanger mirror those of the condenser and evaporator in the vapor compression cycle, respectively. The ambient heat exchanger (condenser) aims to maintain one end of the stack at ambient temperature by dissipating heat to a circulating fluid. Consequently, fluid at ambient conditions can be pumped to the ambient heat exchanger of each thermoacoustic refrigerator. For effective district cooling, multiple evaporators may be interconnected.

According to example embodiments of the present disclosure, a thermoacoustic engine (TAE) is a device that converts thermal energy to acoustic energy. Two types of TAEs are discussed herein (but others may be employed where suitable), namely standing wave and traveling wave engines which both have the same components but different configurations depending upon the wave generated, (e.g., traveling wave or standing wave). A component of TAE is the stack/regenerator, which can be or can include a series of small tubes or plates placed inside a resonator where the conversion of heat to work takes place. In standing wave thermoacoustic systems, the core component where thermal-acoustical conversion takes place is commonly referred to as the “stack.” On the other hand, in traveling-wave thermoacoustic systems, the corresponding component is typically termed the “regenerator”. It is a porous solid including a series of plates stacked parallel or in a concentric ring or spiral arrangement, which gives the stack its porosity. The primary distinction between a regenerator and a stack lies in a hydraulic radius (rh). The hydraulic radius is mathematically defined as rh=A/Π, where A represents a plate area, and Π is a perimeter length. For the stack, rh≥δk, while for the regenerator, rh<<δk, where δk is the “thermal penetration depth”. TAE has the advantage of running on solar heat or on waste heat, such as that coming from the exhaust of a steam/gas turbine or a diesel engine. The resonator is typically a long, narrow tube containing environmentally friendly working gas, such as helium or air. The resonator serves to amplify the generated sound wave. The properties of the resulting acoustic wave, including velocity, pressure, and frequency, are determined by the length of the resonator and the placement of the TAE stack. The stack is placed between two heat exchangers, a hot heat exchanger (HHX) at one end and a low or ambient heat exchanger (AHX) on the other end.

The heat is applied (Qᵢₙ) at one side of the stack via HHX, and the opposite end of the stack is typically fixed at the ambient temperature by removing heat (Qₒᵤₜ) via AHX. The temperature gradient in stack is developed, which is a result of the heat transfer from the heat source to the gas in the stack. The gas parcel in the stack experiences cyclic thermal expansion and contraction at high and low pressures, respectively, thereby producing acoustic work. The expansion and contraction of the gas results in the generation of sound waves that propagate through it. Depending on the design of the TAE, these waves can form either a standing wave or a traveling wave. These sound waves can be used to power an engine to produce electricity or can be directly used in a thermoacoustic refrigerator to produce a cooling effect. Thermoacoustic engines designed for low temperature applications offer distinct advantages, including cost-effectiveness, enhanced reliability, and operational simplicity, setting them apart from conventional mechanical engines (e.g., Stirling engines).

A thermoacoustic refrigerator (TAR), contrary to the TAE, uses a sound wave to pump heat from a cold source to a hot source, which creates a temperature difference and a cooling effect. Similar in construction to TAE, the TAR can include a resonator, the stack/regenerator, the heat exchangers, and additionally an acoustic driver. The TAR uses acoustic power to remove heat from a low temperature source to a higher temperature source. The acoustic driver is the component that generates the sound waves within the resonator. It can be any device that produces sound waves (e.g., TAE). To prevent heat from entering the refrigerator from the surroundings, the refrigerator is surrounded by thermal insulation. This insulation can be made of materials such as foam or fiberglass. The utilization of such a system offers notable advantages, including stability, reliability, simplicity, and longevity, owing to the absence of moving components. Thermoacoustic refrigerators can be used in a number of applications, including but not limited to storing food and medical supplies, refrigerators in transportation vehicles, air conditioning systems for buildings and vehicles, cryogenic cooling systems for medical and scientific applications, and cooling systems for electronic devices.

From a thermodynamic standpoint, standing wave and traveling wave devices exhibit distinct operational characteristics. In a standing wave device, there is a nearly ninety degree phase lag between pressure and velocity. Additionally, thermally imperfect contact is used to separate the expansion and compression of portions of fluid from the cooling and heating processes. Moreover, compression occurs when the pressure undergoes a significant increase, while displacement takes place at high velocity. The fluid position in relation to time can be determined by taking the time integral of velocity. This synchronization ensures that the fluid's displacement is aligned with the corresponding pressure changes. Consequently, an optimal change in displacement happens substantially simultaneously during compression. Likewise, expansion is also matched with displacement, but in the opposite direction, occurring when the pressure experiences its most substantial decrease.

A parameter in standing wave thermoacoustic devices is the “critical temperature gradient” (ΔT_{critical}). This gradient refers to the variation in temperature along the length of the stack in the direction of acoustic wave propagation. When this temperature gradient exceeds the critical value, the device operates as a prime mover or engine. Conversely, when the temperature gradient falls below the critical value, the device functions as a refrigerator or heat pump. The critical temperature gradient serves as a threshold that determines the mode of operation for the standing wave thermoacoustic device. However, it may not be confused with the “onset temperature gradient” (ΔTₒₙₛₑₜ), which represents the gradient at which the natural perturbations in the fluid are amplified enough to overcome the effects of viscous and thermal attenuation, thus producing an acoustic wave. Minimizing the difference between these gradients results in the lowest onset temperature for a given standing wave thermoacoustic device. This ensures that the natural perturbations in the fluid are sufficiently amplified to generate an acoustic wave, optimizing the device's performance. By leveraging the thermodynamic properties of sound waves, thermoacoustic engines and refrigerators offer simplicity, reliability, and environmental friendliness. They can also operate on a wide range of fuels, including natural gas, propane, and biomass, making them versatile and flexible in terms of energy sources.

Thermoacoustic technology has several advantages over traditional energy conversion technologies. As mentioned, conventional refrigeration uses the vapor-compression cycle, which needs several expensive moving parts susceptible to breakdown and a refrigerant for its operation. Thermoacoustic heating and cooling can be a promising technology since it uses environmentally friendly fluids, incurs a low cost, and consists of a simple design without moving parts that avoid hefty maintenance. It is a clean and efficient process that does not require complex machining, such as turbines or compressors, and it does not produce emissions or pollutants. It is also a modular, retrofittable, and scalable technology that can be adapted to different applications and power outputs. Thermoacoustic devices have potential applications for fluid mixture separation, natural gas liquefaction, heat pumps, electric generators, pulse tube refrigerators, and thermoacoustic refrigerators. Further, thermoacoustic technology has the potential to revolutionize a wide range of industries, including district cooling, automotive, aerospace, and renewable energy. It can also be used in the desalination industry to convert saltwater into freshwater using freeze desalination.

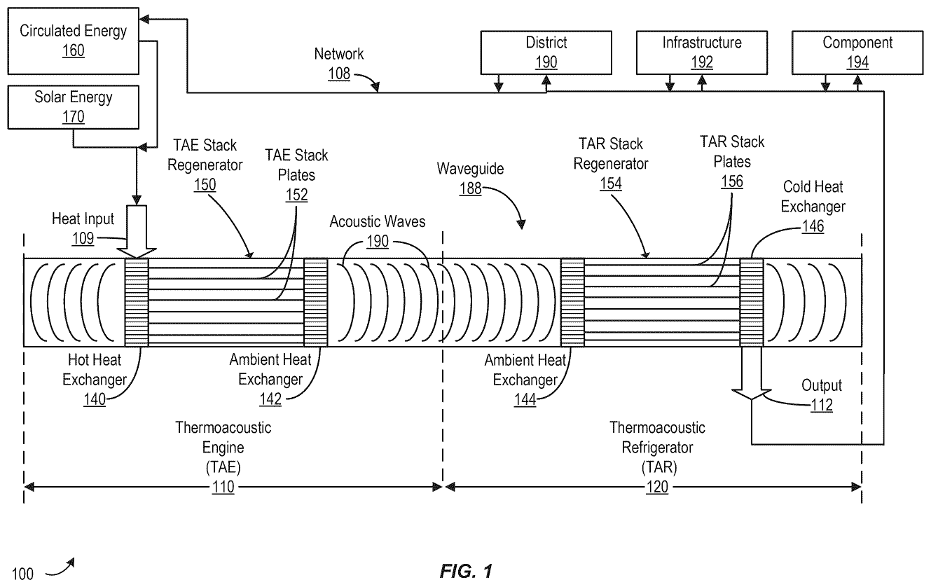

FIG. 1 is a simplified diagram of an example thermoacoustic device 100 connected to a network 108, according to some embodiments. The thermoacoustic device 100 includes a waveguide 188 containing a thermoacoustic engine (TAE) 110 and a thermoacoustic refrigerator (TAR) 120. The waveguide 188 may be at least partially transparent to one or more wavelengths of light (e.g., from two hundred nanometers (nm) to one millimeter (mm)) or at least partially opaque to one or more wavelengths (e.g., from two hundred nm to one mm). For example, the waveguide 188 may be transparent to visible light between four hundred nm and seven hundred nm. The waveguide 188 may be sealed at one or both of a first end (e.g., left side) and a second end (e.g., right side) and be configured to contain a fluid (e.g., air, environmentally friendly gases, etc.). The waveguide 188 includes a length between the first end and the second end that may be in a range between simple straight tube of thirty centimeters (cm) and to a looped tube of twenty meters (m) and a diameter in a range between a few cm and to tens of cm. In some examples, the waveguide 188 may include one or more sections which are substantially cylindrical, however, it should be understood that any suitable shapes may be implemented as the one or more sections. The waveguide 188 may be made of a material including, without limitation, recycled materials (e.g., polyethylene terephthalate (PET), high density polyethylene (HDPE), etc.), polymers (e.g., styrene-acrylonitrile (SAN), polycarbonate, etc.), glass, or combinations thereof.

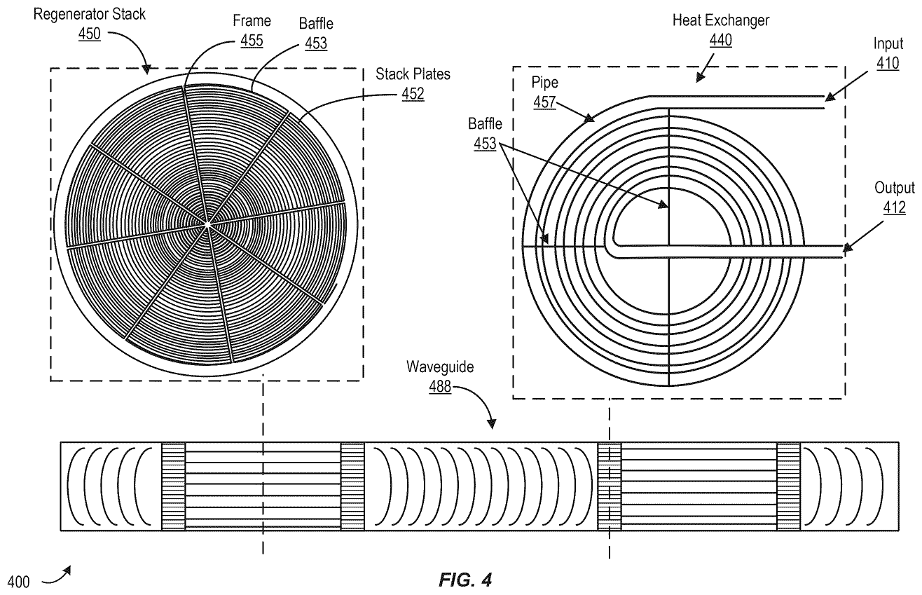

As previously mentioned, the waveguide 188 includes a TAE 110 located at a distance along the waveguide 188 between the first and second end of the waveguide 188. For example, the TAE 110 may be located (e.g., centered) at a third of the total distance between the first end and the second end of the waveguide 188. The TAE 110 is configured to receive a heat input 109 by way of an input to an internal compartment (e.g., input 410 to pipe 457 with respect to FIG. 4). The heat input 109 may be from renewable (e.g., solar energy 170) or “waste” resources (e.g., circulated energy 160). While the term “waste” will be used throughout this disclosure, it should be readily understood to one skilled in the art that the term “waste” is intended to mean any suitable heat source where heat is a byproduct of operations or otherwise not dedicated to another purpose and/or could readily and suitably be harnessed for use as described herein. For example, steel smelting plants produce excess heat while producing steel which could be circulated to the TAE 110. The heat input 109 is provided to a TAE hot heat exchanger (TAE HHX) 140 (e.g., discussed in more detail with respect to heat exchanger 440 of FIG. 4) which is configured to convert and/or transfer the thermal energy from the heat input 109 to heat a fluid within the waveguide 188 (discussed in more detail later).

The TAE 110 includes a TAE stack regenerator 150 which may include TAE stack plates 152 configured between the TAE HHX 140 and a TAE ambient heat exchanger (TAE AHX) 142. While the TAE AHX references the term “ambient”, it should not be considered limiting and it should be readily understood by one skilled in the art that the term is used to denote a temperature difference from the TAE HHX 140 and can be construed as a low-heat heat exchanger when not connected to an “ambient” load undergoing temperature changes. The TAE stack plates 152 are configured to allow the fluid within the waveguide 188 to pass through from the first end to the second end of the waveguide 188. In some examples, the TAE AHX 142 may include an output (not depicted) coupled to an ambient environment. The TAE stack regenerator 150 includes a TAE temperature differential, ΔT_{TAE}, defined between the HHX 140 and the AHX 142 due to one or more acoustic waves 190 within the waveguide 188. The TAE stack plates 152 are suitably thermally conductive to effectively form the temperature differential with a higher thermal energy (e.g., hotter) closer to the HHX 140 and a lower thermal energy (e.g., cooler) closer to the AHX 142.

As previously discussed, the TAE 110 functions to generate one or more acoustic waves 190 (e.g., standing wave, traveling wave, etc.) within the waveguide 188 due to one or more temperature differentials, ΔTₙ, where n is the number of TAEs 110 and TARs 120. While the acoustic waves 190 are depicted as curved lines, it should be understood that these curved lines are not intended to depict a preferred direction, amplitude, size, or position unless otherwise stated. One readily skilled in the art would recognize that the curved lines representing the acoustic waves 190 are drawn to provide clarity of the presence of the acoustic waves 190 in various sections of the waveguide and areas that include components such as the TAE stack regenerator 150 also include the acoustic waves 190, but the curved lines were not illustrated on top of the TAE stack regenerator 150 for the sake of clarity of discussion. In some examples, the acoustic waves 190 may include a standing wave of one or more orders which oscillates between the first and second end of the waveguide 188.

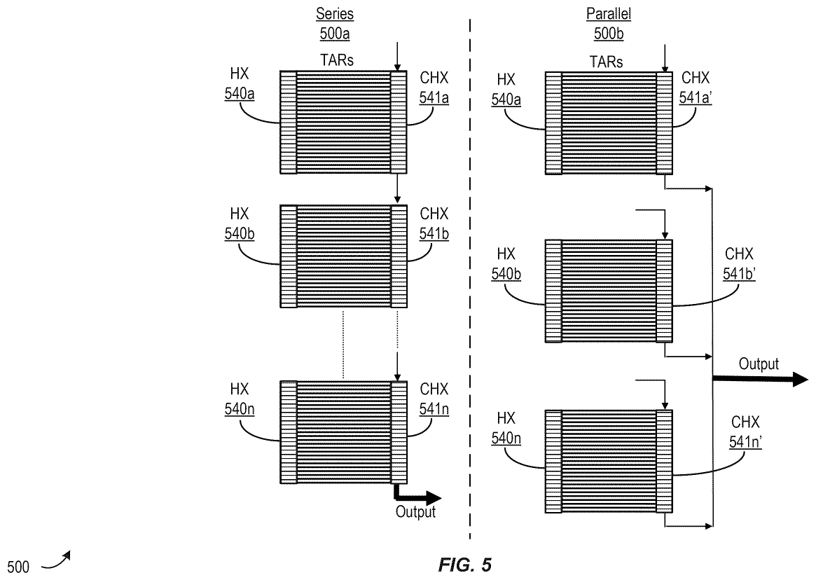

The TAR 120, similar to the TAE 110, includes an ambient heat exchanger (AHX) 144, a TAR stack regenerator 154, and a cold heat exchanger (CHX) 146. The TAR stack regenerator 154 may include one or more TAR stack plates 156 configured between the AHX 144 and the CHX 146. As the acoustic waves 190 oscillate and create pressure differentials, a TAR temperature differential, ΔT_{TAR}, across the TAR stack regenerator 154 is generated with a higher thermal energy (e.g., hotter) closer to the AHX 144 and a lower thermal energy (e.g., cooler) closer to the CHX 146. The CHX 146 may be coupled to an output 112. For example, the CHX 146 may include an internal compartment (e.g., pipe 547 with respect to FIG. 5) for circulating a substance (e.g., fluid) and changing the temperature (e.g., cooling) of the substance.

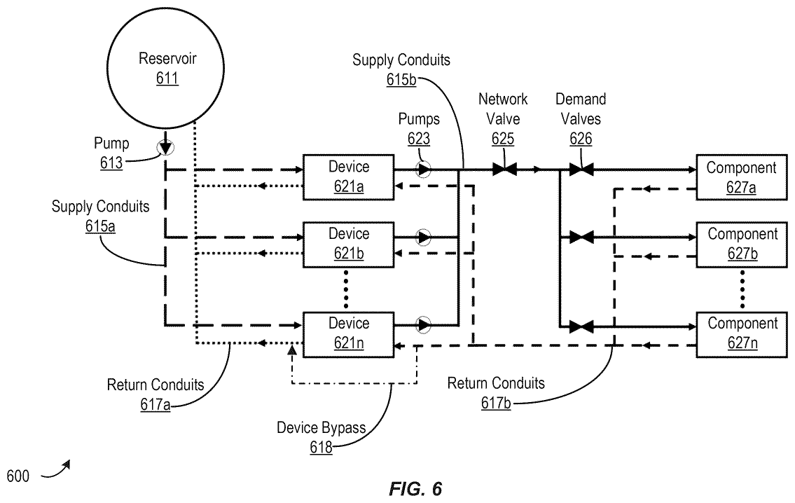

The output 112 may be operably and suitably connected to one or more pumps (e.g., pump 623 with respect to FIG. 6) for distributing the thermally altered fluid to one or more connected devices over a network 108 (e.g., a network of supply conduits 615a/b and return conduits 617a/b with respect to FIG. 6). In a non-limiting example, the connected devices may include components 194 (e.g., data centers, refrigerators, etc.), infrastructure 192 (e.g., public water utilities, smelting facilities, etc.), and/or districts (e.g., villages, cities, towns, etc.) that may benefit from the cooler fluid.

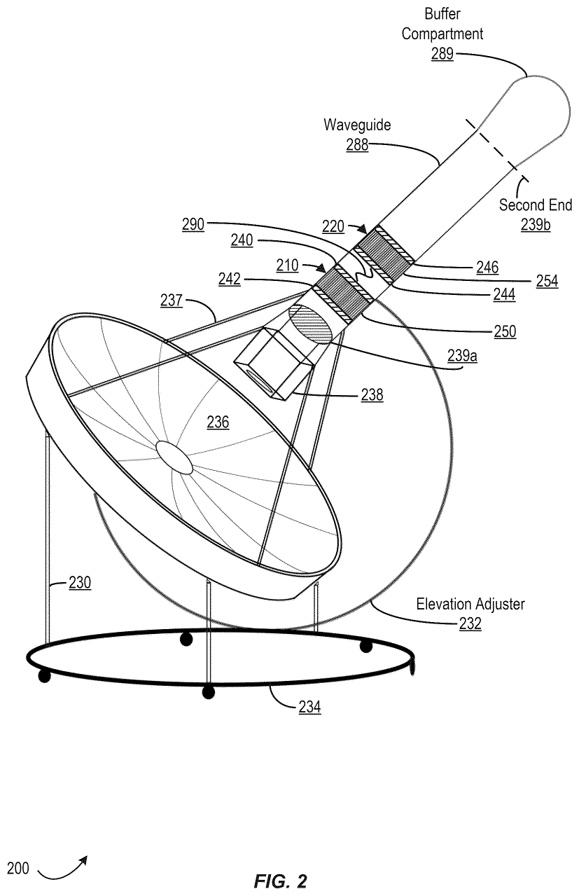

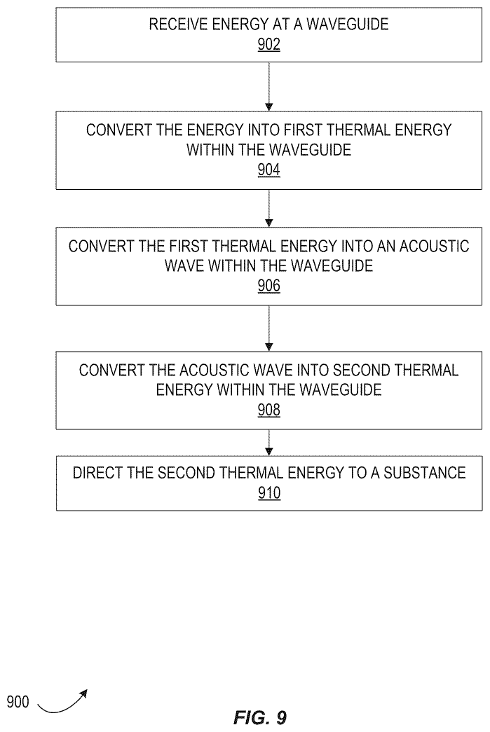

FIG. 2 is a simplified diagram of an example solar thermoacoustic device 200, according to some embodiments. The solar thermoacoustic device 200 may include, and/or be suitably connected to, one or more components as described in FIGS. 1, 3-7, and 10, and may operate according to processes described in FIG. 9. The solar thermoacoustic device 200 may include a collector 236 configured to collect energy (not depicted). For example, the collector 236 may be a parabolic reflector (e.g., mirror) configured to collect solar energy (e.g., sunlight) and redirect (e.g., focus) the solar energy towards a receiver 238. The receiver 238 may be a cavity receiver and include an aperture for receiving the energy from the collector 236. In some examples, the receiver 238 may be a cavity receiver which has a high energy concentration ratio and higher temperature limit due to a suitably sized aperture. The high energy concentration ratio provided by the collector 236/receiver 238 may be in a range between one hundred to five thousand. Due to the optimal high energy concentration ratio, higher temperature gradients and increased efficiency of a TAE 210 may be achieved.

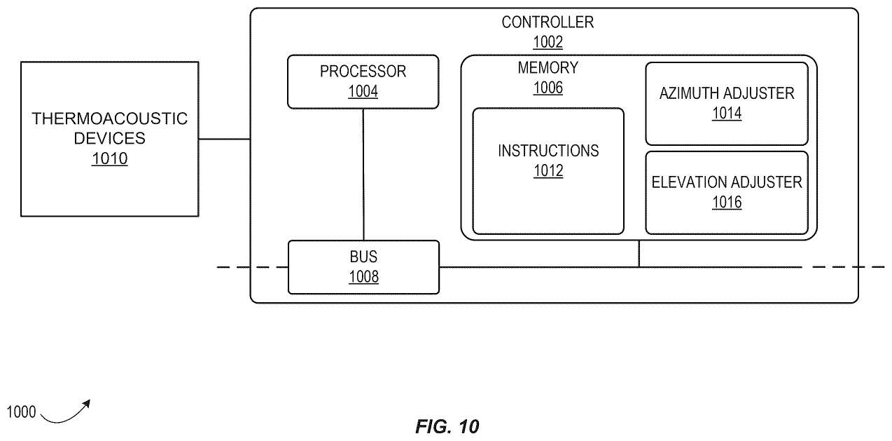

In some examples, the collector 236 may be mounted on a structure 230 (e.g., support frame). The structure 230 may include suitable rotation and/or translation components such as a translatable and/or rotatable structure that enables pitch (azimuth), roll, and yaw adjustments of some or all supported components (e.g., collector 236, waveguide supports 237, etc.). For example, an azimuth adjuster 234 may control an azimuth angle of collector 236 to adjust for daily changes in solar energy as the Sun rises and falls to ensure optimum solar energy capture. An elevation adjuster 232 may be configured to control a tilt of the collector 236 to account for a position of the Sun as it crosses the sky. Together the azimuth adjuster 234 and elevation adjuster 232 are able to account for any position of the Sun throughout the year at any suitable location on Earth. The azimuth adjuster 234 and the elevation adjuster 232 may be controlled automatically (e.g., controller 1002 with respect to FIG. 10) and/or controller manually (e.g., user controlled). The structure 230 may include materials including, but not limited to, recycled materials (e.g., polyvinyl chloride (PVC) supports), wood, alloys, metals (e.g., aluminum), or combinations thereof.

Now returning to the discussion of the receiver 238, the receiver 238 may relay the energy from the collector 236 towards a first end of a waveguide 288. In some examples, the first end 239a of the waveguide 288 may be a closed end (e.g., a coupling end for standing waves). The first end 239a of the waveguide 288 may be made of a thermally conductive material (e.g., a metal) to allow an optimal amount of heat to reach a hot heat exchanger (HHX) 242 of a thermoacoustic engine (TAE) 210, through direct thermal conduction. The circumference outside of the first end 239a of the waveguide 288 may be thermally insulated by thermal insulation such as, but not limited to, a reflective coating, a cloth sheath, and/or an encapsulation that is well suited for thermal containment. The thermal insulation may be configured to not impede or otherwise interfere with energy transfer from the receiver 238 to the waveguide 288.

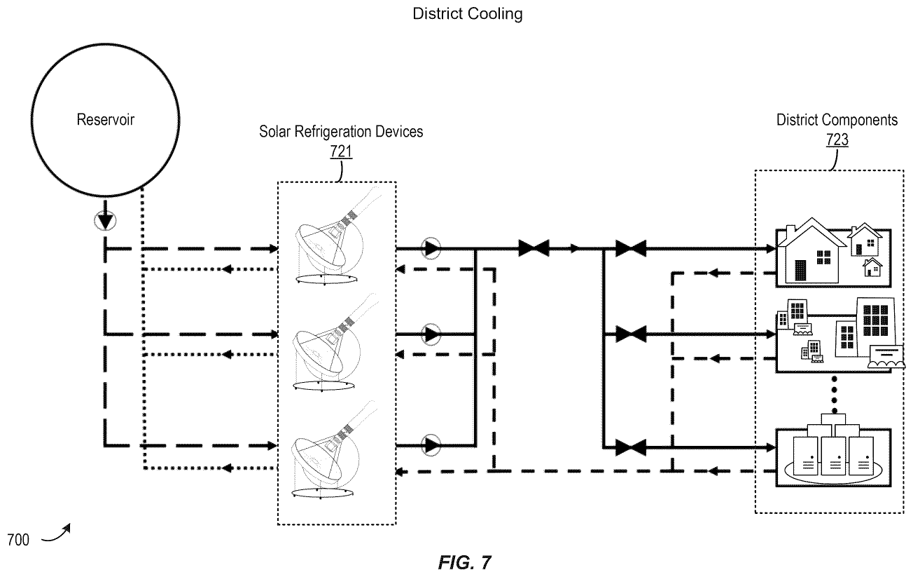

As discussed previously, an acoustic wave 290 (e.g., acoustic wave 190 with respect to FIG. 1) is created within the waveguide 288 once the HHX 242 begins to increase in temperature thus creating pressure differentials which translate to temperature differentials within a thermoacoustic engine stack regenerator 250 and, subsequently, a thermoacoustic refrigerator (TAR) stack regenerator 254 within a thermoacoustic refrigerator (TAR) 220 by way of a heat pumping effect. The TAR stack regenerator 254 converts the acoustic wave 290 to a temperature differential across the TAR stack regenerator 254, causing the cold heat exchanger (CHX) 246 to reach a lower temperature relative to an ambient heat exchanger (AHX) 244. The CHX 246 may be connected to one or more fluids (e.g., water, coolants, etc.) for cooling the fluid (e.g., from twelve degrees Celsius (C) to four degrees C.). In some examples, the solar thermoacoustic device 200 may be connected to another solar thermoacoustic device 200 (e.g., solar refrigeration devices 721 with respect to FIG. 7).

The waveguide 288 may include thermal insulation. For example, the waveguide 288 may include insulation tape wrapped around a perimeter of the waveguide 288 between AHX 240 and a second end 239b of the waveguide 288 to ensure good thermal containment and optimal efficiency. The type of thermal insulation should not be considered limiting, and any suitable type of thermal insulation may be used such as coatings, paint, fabrics, resins, or combinations thereof.

The waveguide 288 may include a buffer compartment 289 attached to the second end 239b. In some examples, the buffer compartment 289 includes a tapered expanded diameter as a function of increasing distance from the second end 239b with a closed end which effectively contains the fluid within the waveguide 288. The buffer compartment 289 may be suitably sized and configured to serve as an expansion volume for heated fluids within the waveguide 288 to ensure that the waveguide 288 does not become damaged during operations by increased pressures and temperatures.

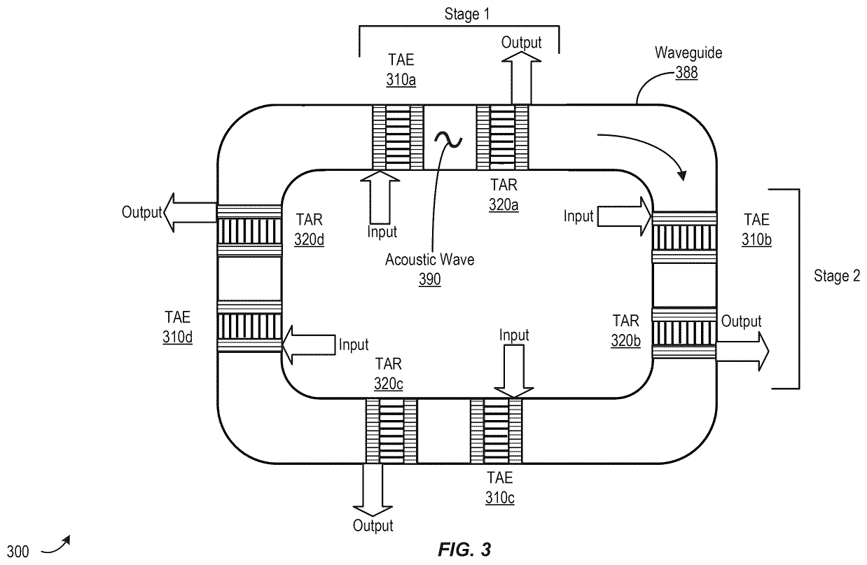

FIG. 3 is a simplified diagram of an example traveling wave thermoacoustic device 300, according to some embodiments. The traveling wave thermoacoustic device 300 may include, and/or be suitably connected to, one or more components as described in FIGS. 1, 2, 4-7, and 10, and may operate according to processes described in FIG. 9. The traveling wave thermoacoustic device 300 includes multiple stages (e.g., stage 1, stage 2, etc.) connected in series with one another. In this configuration, heat (e.g., heat input 109 with respect to FIG. 1) may be supplied to a hot heat exchanger (HHX) of one or more of the TAE 310a-310d to induce a traveling wave due to a thermal gradient maintained across a TAE regenerator stack. Due to not having ends within a waveguide 388, the acoustic wave 390 travels to one or more a thermoacoustic refrigerators 320a-320d which may absorb thermal energy at a cold heat exchanger (cold heat exchanger 146 with respect to FIG. 1) and rejects heat at the ambient heat exchanger (ambient heat exchanger 144 with respect to FIG. 1).

With this series configuration, several advantages such as higher efficiency and lower temperature are achieved making it optimal for district cooling applications. For example, employing the traveling wave thermoacoustic device 300 in place, or in addition to, the standing wave device of the solar thermoacoustic refrigeration device 200, efficient and cost-effective cooling may be produced. While only four stages with inputs and outputs are depicted, it should not be considered limiting, and one skilled in the art would recognize that any suitable number of TAE 310 and TAR 320 may be used (e.g., from two to twenty).

The traveling wave thermoacoustic device 300 may operate at lower hot end temperatures which translates to less solar energy needed to operate effectively. In addition, or alternatively, using alternative heat sources like solar parabolic troughs or waste heat from smelters of steel or aluminum or even manufacturing industries which produce copper cable provides substantial operation flexibility in using an adequate source of heat to operate the traveling wave thermoacoustic device 300. This hybrid approach combining solar energy with industrial heat can further enhance the sustainability and efficiency of a thermoacoustic refrigeration system. In this example, heat (e.g., waste heat) from industrial processes may be captured and may be fed to the TAE 310a. The integration of heat also provides a continuous and stable heat source, complementing the intermittent nature of solar energy and ensuring consistent cooling performance even during periods of low solar irradiance. In some examples, the thermoacoustic device 100 which operates with a standing wave configuration may be integrated with the traveling wave thermoacoustic device 300 in a cascade configuration.

FIG. 4 depicts simplified cross-section diagrams 400 of an example regenerator stack 450 and a heat exchanger 440 used in a thermoacoustic device, according to some embodiments. The heat exchanger 440 features a spiral pipe design that may substantially correspond to the geometry of the regenerator stack 450. For clarity, the heat exchanger 440 is depicted in an enlarged format, highlighting the input 410 and output 412. In some embodiments, the regenerator stack 450 and the heat exchanger 440 on either side of the stack are integrally fabricated as a single unit using 3D printing technology. Despite being manufactured as a unified structure, the materials used for the regenerator stack 450 and the heat exchangers 440 may differ. For instance, the regenerator stack 450 can be constructed from a material such as Mylar®, while the heat exchangers 440 may include a thermally conductive material (e.g., copper). The regenerator stack 450 may include, and/or be suitably connected to, one or more components as described in FIGS. 1-3, 5-7, and 10, and may operate according to processes described in FIG. 9. The cross-sections depicted by the dashed line represent a vertical cross-section cut-out of a section of a waveguide 488 rotated ninety degrees out of the page for clarity. The regenerator stack 450 may include several stack plates 452, one or more baffles 453, and/or a frame 455. The stack plates may be configured, without limitation, as one or more spirals, one or more concentric circles, one or more parallel substrates, a honeycomb configuration, a square mesh configuration, a triangular configuration, a repeating shape pattern, a pin array pattern, or combinations thereof. The regenerator stack 450 may include a material, without limitation, a material selected from a group comprising: a metal (e.g., steel), an alloy, a ceramic, a composite, a polymer, an organic compound, a foam, or combinations thereof, wherein the TAE regenerator and the TAR regenerator may include different materials. In some examples, the regenerator stack 450 and/or the heat exchanger 440 may be “3D” printed by way of additive manufacturing.

The frames 455 and baffles 453 may be configured to support the stack plates 452 with suitable spacing between individual stack plates 452 and enable good fluid flow between the stack plates 452 during operation. For example, the spacing between the individual stack plates 452 may be around two to five times a thermal penetration depth (e.g., a distance heat can diffuse away from a solid part in the stack plates 452). A porosity (e.g., blockage ratio) may be in a range between 0.5 and 0.9.

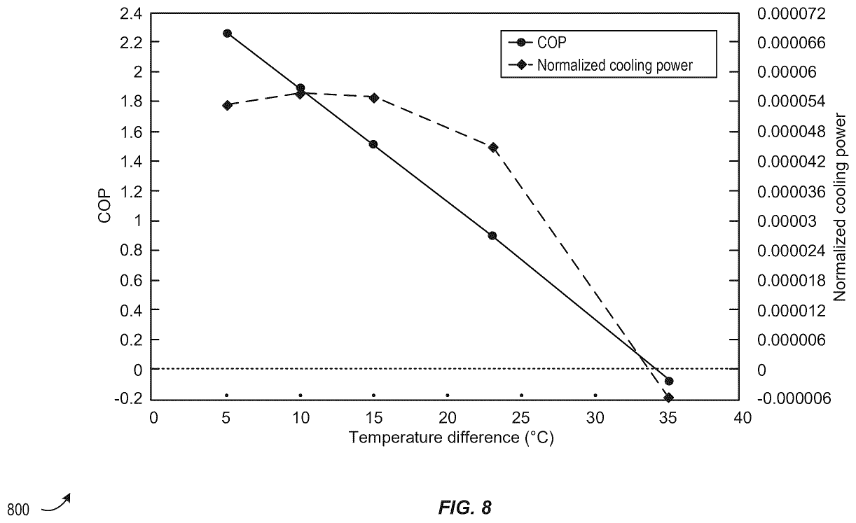

The heat exchanger 440 may include a pipe 457 for receiving a fluid, or suitable heat transfer substance, from input 410 and circulating the fluid away from the waveguide 488 by way of output 412. The heat exchanger 440 may be in direct thermal contact with the stack plates 452, featuring a spiral configuration which may be identical to that of the regenerator stack 450. In some examples, the configurations may provide a precise 1:1 geometric match between the heat exchanger 440 and the regenerator stack. In some embodiments, the stack plates 452 and the heat exchangers 440 are fabricated as a single unit using advanced 3D printing techniques. This non-limiting shell-and-tube heat exchanger configuration provides efficient fluid flow while substantially mitigating flow perturbations by maintaining direct contact between the heat exchanger 440 and the stack plates 452. The integration of hot and cold heat exchangers directly with the stack in a thermoacoustic system, enabled by 3D printing advancements, offers substantial performance improvements. These include a ten to twenty percent increase in acoustic energy conversion efficiency and a five to fifteen percent enhancement in thermal efficiency (COP as discussed in more detail with respect to FIG. 8) by minimizing thermal losses and optimizing thermal gradients. The compact, single-piece design facilitated by 3D printing reduces overall system volume by twenty to thirty percent and minimizes losses at joints or interfaces. Additionally, 3D printing enables material customization for enhanced thermal and mechanical properties, rapid prototyping for accelerated research and development, and monolithic structures that lower maintenance requirements by twenty-five to forty percent while improving durability. Furthermore, precise designs for sound wave channels improve acoustic power retention by ten to fifteen percent providing consistent system performance. In a non-limiting example, the stack plates 452 may be steel spirals that are rolled with gaps between adjacent plates. The heat exchanger's pipe 457 may be a tube (e.g., copper tube) that receives the fluid from the input 410 to promote good heat transfer between the heat exchanger 440 and the stack plates 452. The fluid may then be pumped away by way of output 412 thus carrying away cooler or hotter fluids, respectively depending on the desired operation. The thermal energy may be exchanged between pipe 457 and the stack plates 452 by way of thermal conduction, and between the pipe 457 and the fluid by way of conduction and convection. It should be recognized by one skilled in the art that any suitable thermal energy transfer mechanism may be employed in either order (e.g., convection to conduction) in order to transfer the thermal energy to the fluid or from the fluid.

In addition to the aforementioned improvements, the performance and durability of the heat exchanger 440 can be further improved by using advanced materials such as graphene-coated ceramics and high-temperature alloys. These materials offer superior thermal conductivity and can withstand extreme temperatures without significant degradation. For instance, graphene coatings can significantly enhance heat transfer rates while providing corrosion resistance. High-temperature alloys, such as nickel-chromium based superalloys (e.g., Inconel), can endure prolonged exposure to high temperatures, making them ideal for the waveguide 488 and the setup components. Utilizing these advanced materials can lead to increased efficiency and longevity of the thermoacoustic refrigeration systems of the present disclosure, ensuring reliable operation in demanding environments.

FIG. 5 is a simplified diagram of example arrangements 500 of thermoacoustic devices, according to some embodiments. The arrangements 500 may include, and/or be suitably connected to, one or more components as described in FIGS. 1-4, 6-7, and 10, and may operate according to processes described in FIG. 9. The arrangements 500 depicted show two stack regenerator configurations, one in a series configuration 500a and one in a parallel configuration 500b. The roles of an ambient heat exchange (HX) 540a-540n, where n is the total number of thermoacoustic refrigerators (TARs) in a connected network of waveguides (e.g., waveguide 188), and cold heat exchanger (CHX) 541d-541n mirror those of the condenser and evaporator in the vapor compression cycle, respectively. Each TAR depicted may be connected to an associated thermoacoustic engine (TAE) (not depicted).

By way of example HX 540a aims to maintain one end of the stack at ambient temperature by dissipating heat to a circulating fluid. Consequently, fluid at ambient conditions can be pumped to the HX of each thermoacoustic refrigerator. For effective district cooling, multiple evaporators may be interconnected. The series configuration 500a first involves dividing a cooling process into multiple stages, where each TAR contributes to reducing a small portion of the desired temperature decay. Each TAR can be seen as a small part of a larger thermodynamic cycle. The output of each TAR is fed into the subsequent TAR. For example, an output (e.g., a fluid conduit) of a cold heat exchanger (CHX) 541d feeds an input of a CHX 541e which subsequently feeds the next CHX and so on until reaching a final CHX 541n, where n is a total number of CHX in the configuration 500a. In this configuration, the fluid that is being transported may be subsequently cooled to a further extent thus increasing the efficiency of cooling across the series configuration 500a.

The parallel configuration 500b includes multiple TARs configured in parallel, allowing each unit to independently decrease the temperature of a portion of the fluid to a desired level. This configuration offers good reliability, as a malfunction of one unit does not affect the overall refrigeration process, and it can be replaced while the system is running. In the parallel configuration 500b, the outputs of some or all of CHX 541a′-n′ of the TARs may be connected together to a unified output. In some examples, a hybrid option combining the series configuration 500a and the parallel configuration 500b using multi-stage approaches provides enhanced flexibility for various applications (e.g., district cooling, infrastructure, etc.).

FIG. 6 is a simplified diagram of an example heat exchange network 600 using thermoacoustic devices, according to some embodiments. The heat exchange network 600 may include, and/or be suitably connected to, one or more components as described in FIGS. 1-5, 7, and 10, and may operate according to processes described in FIG. 9. The heat exchange network 600 may include a reservoir 611 for containing one of more fluids (e.g., water, gas, coolant, etc.) configured to be pumped (e.g., using pump 613) towards one or more thermoacoustic devices 621a-621n using one or more supply conduits 615a, where n is the total number of thermoacoustic devices connected in the heat exchange network 600. The thermoacoustic devices 621a-621n are configured to receive the fluids from the reservoir 611 by way of supply conduits 615a to provide a cooling effect (as discussed with respect to FIG. 1) to the fluids. One or more pumps 623 may function to pump the fluids from the devices 621a-621n towards one or more components 627a-627n (e.g., towns, villages, infrastructure) connected to the heat exchange network 600. One or more network valves 625 may function to selectively connect and/or disconnect the devices 621a-621n from one or more of the components 627a-627n. In some examples, one or more demand valves 626 may be connected to the components 627a-627n to selectively add and/or remove individual components 621 from the heat exchange network 600 depending on demands and needs.

By way of example, once the devices 621a-621n are operational, the cooled water (e.g., four degrees C.) is supplied via pumps 623 through supply conduits 615b. The flow of the cooled fluid may be regulated by the network valve 625 that disconnects/connects all the components 627 (e.g., building/customers) to the chilled water network where demand valves 626 may be used to regulate the water flow as per the demand by consumers. The fluid may then be returned from consumers at a temperature of around twelve degrees C. via pipelines to the devices 621a-621n to start the cooling process again. In some examples, a device bypass 618 may direct the return fluid towards the reservoir 611 (e.g., water tower) without being acted upon by the devices 621a-621n.

FIG. 7 is a simplified diagram of an example heat exchange network 700 using solar thermoacoustic devices, according to some embodiments. The heat exchange network 700 may include, and/or be suitably connected to, one or more components as described in FIGS. 1-6 and 10, and may operate according to processes described in FIG. 9. By way of example, the heat exchange network 700 may include any suitable number of solar refrigeration devices 721 (described in more detail with respect to FIG. 2) connected in series, parallel, or a hybrid connection (e.g., hybrid as described with respect to FIG. 5) to cool one or more district components 723 connected to the network. The district components 723 can include, without limitation, residential buildings, commercial buildings, industrial buildings, agricultural infrastructure, or components thereof. The amount of solar refrigeration devices 721 can be scaled appropriately to meet demand of the district components 723 as will be discussed in the next example.

In a non-limiting example according to some embodiments, and referring to a simplified diagram of an example cooling power graph 800 for a thermoacoustic device of FIG. 8, to establish a baseline for scaling the solar refrigeration devices 721 to meet the demands of district components 723, determining a cooling efficiency can provide an effective scaling metric. For a given solar refrigeration device 721 using argon as a working fluid with a thermoacoustic engine (TAE) stack regenerator (e.g., TAE stack regenerator 150) length normalized along a waveguide 188 of 0.165 and a thermoacoustic refrigerator (TAR) stack regenerator (e.g., TAR stack regenerator 154) length normalized along a waveguide 188 of 0.1, respectively. The TAE stack regenerator and the TAR stack regenerator may be placed at normalized positions along the waveguide at 0.247 and 0.577, respectively. Normalizations may be calculated as lₙ=kl and xₙ=kx, where k is a wave number, 1 is the stack length in meters, and x is the stack central location.

With spiral shaped stack plates within the TAE stack regenerator and the TAR stack regenerator, and a spacing between the spiral approximately three times the thermal penetration depth with a porosity of 0.8, a cooling power and Coefficient of Performance (COP) (depicted along the y-axis) may be calculated for different temperature gradients (depicted along the x-axis). For the purposes of this example, one or more ambient heat exchangers (AHX) (e.g., AHX 144 with respect to FIG. 1) may be held at a temperature of twenty-seven degrees C. Now referring back to the cooling power graph 800, when a cold heat exchanger (CHX) (e.g., CHX 146 with respect to FIG. 1) corresponds to a temperature gradient of twenty-three degrees C. At this point, the normalized cooling power is around 4.5e-5 and the COP is 0.9. Moreover, the efficiency of the TAE stack regenerator, which is the ratio of acoustic power generated to the thermal energy supplied to the hot heat exchanger (e.g., HHX 140 with respect to FIG. 1) is around 10.1%. The temperature of the TAE hot heat exchanger at this point may be nine hundred and twenty seven degrees C.

The aforementioned example may serve as a basis for determining scalability. The normalized cooling power, Q_{cn}, may be described by

$${Q}_{c n} = \frac{{\dot{Q}}_{c}}{{p}_{m} a A} . {\dot{Q}}_{c}$$

is the cooling power in W, pₘ is the mean pressure, a is the speed of sound, and A is the cross-sectional area at the location of the regenerator stack (e.g., TAE or TAR). Assuming, for example, that the temperature remains constant when the system is scaled up, and the fluid's speed of sound, a, is almost constant. Hence, at least variables (pₘ and A) are used determining scaling. As for the regenerator stack's area, it may be constrained by the length of the waveguide, where the regenerator stack/waveguide diameter may be considerably smaller than the waveguides length. The area of the tube at the regenerator stack's location may be calculated based on the waveguide radius r as the common formula A=πr². The cross-sectional area may be increased by increasing the waveguide radius. For example, for a waveguide length of 3.5 m, a waveguide diameter of 0.7 m would be optimal and would provide a cross-sectional area of 0.3848 m². Regarding mean pressure, there may be two important constraints. The first constraint may be the mechanical strength of the waveguide, which has to endure high-pressure during operation. A steel waveguide would be optimal due to its impressive resistance to high pressure. Secondly, increasing a mean pressure increases the fluid's density, which decreases the thermal penetration depth of the working fluid (e.g., argon). To maintain a desired porosity of the regenerator stack, the stack plates (e.g., spirals) may be thinner, introducing manufacturing constraints on the stack. Considering the aforementioned conditions, a mean pressure of four mega-Pascals (MPa) may be implemented. This may result in a spiral thickness of the stack plates of 0.0857 mm and a spacing of 0.2 mm.

Continuing this non-limiting example, and using the previously defined variables, the following equal may be used to calculate the cooling power:

$${\dot{Q}}_{c} = {Q}_{c n} {p}_{m} a A = 0.000045 \times 4000000 \times 326 \times 0.3848 \times \frac{1 kW}{1000 W} \approx 22.58 kW .$$

With the cooling power known, an estimate of the amount of energy the solar refrigeration device 721 produces may be calculated. With a COP of 0.9 and a thermoacoustic engine efficiency at 10.1%, as previously discussed, the power to run the solar refrigeration device 721 may be calculated as:

$$\frac{{\dot{Q}}_{c}}{η \times C O P} = \frac{22.58}{0.1 \times 0.9} \approx 250.9 kW .$$

Assuming around ten percent system losses due to conversion efficiencies, the power may be calculated (250.9 kW/0.9)≈278.7 kW. A collector (e.g., collector 236) of four hundred m² can supply this power as per the following calculation:

$$800 \frac{W}{{m}^{2}} \times \frac{1 kW}{1000 W} \times 400 {m}^{2} = 320 kW .$$

Where eight hundred W/m² is an example average irradiance the collector receives for regions with at least twelve hours of light per day. To calculate a receiver area (e.g., receiver 238 with respect to FIG. 1), a concentration ratio may be reasonably estimated to be 2000, and, as such,

$$\frac{400 {m}^{2}}{2000} \approx 0.2 {m}^{2} .$$

Finally, to satisfy a certain cooling load, multiple solar refrigeration devices 721 may be connected in series, parallel, or a hybrid of the two. For example, to satisfy a 1000 kW cooling load,

$$( \frac{1000}{{\dot{Q}}_{c}} = \frac{1000}{22.58} \approx 44 ) .$$

This means, for this example, that forty-four solar refrigeration devices 721 should be connected to the network to provide satisfactory cooling to district components 723.

FIG. 9 is a simplified block diagram of an example process 900 using a thermoacoustic device, according to some embodiments. The process 900 may incorporate one or more components as described in FIGS. 1-7 and 10. The process 900 may include more or fewer steps than is depicted. The process 900 may be performed in any suitable order. The process 900 may begin at step 902 where a waveguide may receive energy. In some examples, the waveguide (e.g., waveguide 188 with respect to FIG. 1) may receive the energy from a collector (e.g., collector 236 with respect to FIG. 2) by way of a receiver (e.g., receiver 238 with respect to FIG. 2). The energy may be solar energy.

At step 904, the energy may be converted into a first thermal energy within the waveguide. For example, a first temperature differential, which defines the first thermal energy, within the waveguide may be generated by a thermoacoustic engine (TAE) (e.g., TAE 110 with respect to FIG. 1) between a hot heat exchanger (HHX) (e.g., HHX 140 with respect to FIG. 1) and an ambient heat exchanger (AHX) (e.g., AHX 142 with respect to FIG. 1). The temperature differential may include a first temperature at the HHX which is greater than a second temperature at the AHX. For example, the first temperature at the HHX may be in a range between two hundred C and 1000 C. The second temperature at the AHX may be in a range between negative ten C and one hundred C.

At step 906, the first thermal energy may be converted to an acoustic wave within the waveguide. For example, the acoustic wave may be a standing wave or a traveling wave. The acoustic wave (e.g., acoustic wave 390 with respect to FIG. 3) may function to change a pressure within the waveguide across a length of the waveguide. The pressure differential may function to locally increase pressure at one location in the waveguide and decrease pressure at another location.

At step 908, the acoustic wave may be converted into second thermal energy within the waveguide. For example, a regenerator stack (e.g., regenerator stack 450 with respect to FIG. 4) may be positioned such that stack plates within provide a conductive path for heat to be extracted from a low pressure zone thus creating a second temperature differential between an AHX (e.g., AHX 144 with respect to FIG. 1) and a cold heat exchanger (CHX) (e.g., CHX 146 with respect to FIG. 1). The second thermal energy, in the form of the temperature differential, enables the CHX to lower in temperature.

At step 910, the second thermal energy may be delivered to a substance. For example, the second thermal energy may be conductively and/or convectively coupled to a fluid (e.g., water). The CHX may include an output (e.g., output 412 with respect to FIG. 4) configured to circulate fluid away from the waveguide and towards one or more components to be cooled. For example, the circulated fluid may be provided for district cooling applications.

FIG. 10 is a simplified block diagram of an example system 1000 for thermoacoustic devices 1010, according to some embodiments. The system 1000 may include, and/or be suitably connected to, one or more components as described in FIGS. 1-7, and may operate according to processes described in FIG. 9. In some examples, the thermoacoustic devices 1010 and components of system 1000 may be coupled to controller 1002 by way of a communication bus 1008 (e.g., wired connection, wireless connection, etc.) to transmit signals. The components may include one or more processor(s) 1004, non-transitory computer readable medium(s) such as memory 1006, an input/output (I/O) interface(s), and/or encoder(s)/decoder(s). The one or more processor(s) 1004 may execute machine-readable instructions stored on the memory 1006. The one or more processor(s) 1004 may include single core or multi-core processors, Raspberry Pi 4, etc. The memory 1006 may be configured in any suitable configuration. For example, memory 1006 may be volatile memory such as random-access memory (RAM) and/or non-volatile memory such as read-only memory (ROM) and/or flash memory. In addition, or alternatively, one or more processor(s) 1004 and/or memory 1006 may function with the I/O interface(s) to receive signals from the thermoacoustic devices 1010. The I/O interface(s) may include any suitable interface including user interfaces such as computers, controllers (e.g., keyboard, mouse, etc.), or similar. In some examples, encoder(s)/decoder(s) may function to receive signals from the thermoacoustic devices 1010. The encoder(s)/decoder(s) may encode the signals for further communication or may decode the signals for analysis and/or storing in memory 1006 and provide secure communications for the thermoacoustic devices 1010.

An azimuth adjuster 1014 may control an azimuth adjustment of the thermoacoustic devices in order to track an energy source (e.g., the Sun) when used in various regions and/or locations around the world. The azimuth adjuster 1014 may be pre-programmed with instructions or may include adaptive learning (e.g., deep learning algorithms) adapted to determine a suitable azimuth for the thermoacoustic devices to maximize operations. An elevation controller 1016 may control an elevation adjustment of the thermoacoustic devices in order to track an energy source (e.g., the Sun) when used in various regions and/or locations around the world. The elevation controller 1016 may be pre-programmed with instructions or may include adaptive learning (e.g., deep learning algorithms) adapted to determine a suitable elevation for the thermoacoustic devices to maximize operations. In some examples, software, firmware, or hardware instructions may form a heliostat controller to adequately control position, orientation, and rotation of the thermoacoustic devices 1010 using the azimuth adjuster 1014 and the elevation controller 1016 to track a solar position (e.g., azimuth, elevation, etc.).

As used in this application and in the claims, some or all devices, methods, and apparatus discussed herein may be components in one or more networks for connecting communication paths. For example, the thermoacoustic devices 1010 discussed herein may be used for receiving and/or transmitting data packets to and/or from one network to another network. Multiple thermoacoustic devices 1010 may be implemented with one or more networks and work in conjunction with each other. The networks may include software, hardware, or firmware to operate with thermoacoustic devices 1010. In some examples, networks may include, but are not limited to, wide area networks (WAN) (e.g., the Internet), local area networks (LAN) (e.g., university networks), virtual private networks (VPN), internet of things (IOT) networks, any appropriate network/cloud architecture that may facilitate data communications, or combinations thereof.

As used in this herein and in the claims, the terms first, second, etc., are intended to distinguish the particular nouns they modify (e.g., first stack, second stack, etc.) and should not be considered limiting. The use of these terms is not intended to indicate any type of importance, hierarchy, preference of the particular noun. For example, a first stack and a second stack are intended to demonstrate two separate stacks that are not necessarily limited by any importance, hierarchy, and/or preference of the two stacks.

As used in this application and in the claims, the singular forms “a”, “an”, and “the” include the plural forms unless the context clearly dictates otherwise. Additionally, the term “includes” means “comprises”. Further, the terms “couple” or “coupled” or “support” or “supported” does not exclude the presence of intermediate elements between the coupled items and/or supported items.

The devices, methods, systems, processes, and/or techniques described herein should not be considered limiting in any way. Instead, the present disclosure is directed toward all non-obvious and novel features and aspects of the various disclosed embodiments, alone and in various combinations and sub-combinations with one another. The disclosed devices, methods, systems, processes, and/or techniques are not limited to any specific aspect or feature or combinations thereof, nor do the disclosed devices, methods, systems, processes, and/or techniques require that any one or more specific advantages be present. Any theories of operation are to facilitate clear and direct explanation, but the disclosed devices, methods, systems, processes, and/or techniques are not limited to such theories of operation.

Although the operations of some of the disclosed methods are described in a particular, sequential order for convenient presentation, it should be understood that this manner of description encompasses any suitable rearrangement, unless a particular ordering is preferred and/or required by specific language set forth below. For example, operations described sequentially may in some cases be rearranged or performed concurrently. Moreover, for the sake of simplicity, the attached figures may not show the various ways in which the disclosed systems, methods, and apparatuses can be used in conjunction with other devices, methods, systems, processes, and/or techniques. Additionally, the description sometimes uses terms like “produce” and “provide”, and similar to describe the disclosed methods. These terms should be considered as high-level abstractions of the actual operations that are performed. The actual operations that correspond to these terms will vary depending on the particular implementation and are readily discernible by one of ordinary skill in the art. Moreover, the description sometimes uses terms like “substantially”, “approximately”, and similar to describe the disclosed devices and apparatus. These terms may represent an equivalence readily understood to one skilled in the art to within a specific percentage (e.g., +/−five percent, +/−ten percent, etc.) for comparison of structures, ratios, dimensions, ranges, operations, or similar.

In some examples, structural elements, geometric relationships, thresholds, criteria, values, procedures, or apparatuses are referred to as “low”, “minimal”, “optimal”, or the like. It will be appreciated that such descriptions are intended to indicate that a selection among many used functional alternatives can be made, and such selections need not be better, smaller, or otherwise preferable to other selections.

In some examples, relative temperature differences such as “hot” “cool” “cold” “ambient” “hotter” “colder” and similar are used to show clarity of a relative temperature difference between one or more components of the systems, methods, and devices. It will be appreciated that such descriptions are intended to indicate that a relative temperature difference among many used functional temperature alternatives can be made, and such selections need not be limited with colloquial definitions of hot, cold or similar unless otherwise defined.

What is claimed is:

1. A device comprising:
a collector configured to collect energy;
a waveguide;
a thermoacoustic engine (TAE) within the waveguide comprising:
a first TAE heat exchanger configured to receive the energy from the collector and convert the energy into first thermal energy;
a TAE regenerator configured to convert the first thermal energy into an acoustic wave; and
a thermoacoustic refrigerator (TAR) within the waveguide comprising:
a TAR regenerator configured to convert the acoustic wave into second thermal energy; and
a first TAR heat exchanger configured to direct the second thermal energy to a substance.

2. The device of claim 1, wherein the TAE regenerator and the TAR regenerator include a structural configuration selected from a group comprising: one or more spirals, one or more concentric circles, one or more parallel substrates, a honeycomb configuration, a square mesh configuration, a triangular configuration, a repeating shape pattern, a pin array pattern, or combinations thereof.

3. The device of claim 1, wherein the TAE regenerator and the TAR regenerator include a material selected from a group comprising: a metal, an alloy, a ceramic, a composite, a polymer, an organic compound, a foam, or combinations thereof, wherein the TAE regenerator and the TAR regenerator include different materials.

4. The device of claim 1, wherein the TAE has a higher thermal conductivity than the TAR.

5. The device of claim 1, wherein the first TAE heat exchanger further comprises:
a first inlet configured to receive a first fluid;
a first internal compartment configured to circulate the first fluid in proximity to the TAE regenerator to transfer heat between the first fluid and the TAE regenerator; and
a first outlet configured to direct the first fluid out of the first TAE heat exchanger;
wherein the first TAR heat exchanger further comprises:
a second inlet configured to receive a second fluid;
a second internal compartment configured to circulate the second fluid in proximity to the TAR regenerator to transfer heat between the second fluid and the TAR regenerator; and
a second outlet configured to direct the second fluid out of the first TAR heat exchanger; and
wherein the second fluid has a lower temperature than the first fluid.

6. The device of claim 1, further comprising:
a receiver configured to receive the energy from the collector; and
wherein the waveguide further comprises:
a first end coupled to the receiver and configured to receive the energy from the receiver and direct the energy to the first TAE heat exchanger, wherein the first end is closed;
a second end distal from the collector, wherein the second end includes an opening; and
a buffer compartment connected to the second end and configured to permit thermal expansion or contraction of a fluid within the waveguide.

7. The device of claim 1, further comprising:
an azimuth adjuster configured to control an azimuth angle of at least one of: the collector, the waveguide, the TAE, or the TAR;
an elevation adjuster configured to control a tilt angle of at least one of: the collector, the waveguide, the TAE, or the TAR; and
a heliostat controller configured to control at least one of: the azimuth adjuster or the elevation adjuster to track a solar azimuth or elevation.

8. A system comprising:
a first thermoacoustic device comprising:
a collector configured to collect energy from an energy source;
a waveguide configured to receive the energy from the collector;
a thermoacoustic engine (TAE) within the waveguide configured to convert the energy into an acoustic wave;
a thermoacoustic refrigerator (TAR) within the waveguide configured to convert the acoustic wave into thermal energy; and
a fluid network including a conduit that has a fluid, wherein the fluid is configured to exchange the thermal energy with the TAR.

9. The system of claim 8, further comprising:
a second thermoacoustic device coupled to the fluid network and configured to receive the fluid from the first thermoacoustic device at an inlet to a TAR heat exchanger of the second thermoacoustic device, wherein the second thermoacoustic device is in series with the first thermoacoustic device.

10. The system of claim 9, further comprising:
a second thermoacoustic device coupled to the fluid network and configured to contribute a second fluid to the fluid from the first thermoacoustic device, wherein the second thermoacoustic device is in parallel with the first thermoacoustic device.

11. The system of claim 9, further comprising:
a fluid reservoir coupled to the fluid network configured to store an amount of stored fluid, wherein the fluid reservoir is configured to supply the first thermoacoustic device with the fluid and store excess circulated fluid from the first thermoacoustic device.

12. The system of claim 9, further comprising:
a waste fluid network coupled to the fluid network, wherein the waste fluid network is configured to direct one or more waste fluids to the first thermoacoustic device as an input fluid to the TAR.

13. The system of claim 9, wherein the waveguide is configured as a quarter wavelength standing wave waveguide.

14. A method comprising:
receiving, at a waveguide, energy;
converting the energy into first thermal energy within the waveguide;
converting the first thermal energy into an acoustic wave within the waveguide;
converting the acoustic wave into second thermal energy within the waveguide; and
directing the second thermal energy to a substance.

15. The method of claim 14, wherein the energy is converted into the first thermal energy and the first thermal energy is converted into the acoustic wave by a thermal acoustic engine (TAE), and wherein the acoustic wave is converted into the second thermal energy by a thermal acoustic refrigerator (TAR).

16. The method of claim 15, further comprising:
generating a first temperature differential within the waveguide which at least partially overlaps the TAE;
in response to generating the first temperature differential within the waveguide, generating a standing wave including the acoustic wave; and
in response to generating the standing wave, generating a second temperature differential which at least partially overlaps the TAR, wherein a first end of the TAR is at a higher temperature than a second end of the TAR.

17. The method of claim 15, wherein the acoustic wave is a traveling wave, and wherein the method further comprises:
directing the traveling wave towards one or more additional TARs and TAEs, wherein the additional TARs and TAEs are connected in series with the TAR and TAE.

18. The method of claim 14, further comprising:
receiving waste thermal energy; and
directing the waste thermal energy to the waveguide, wherein the first thermal energy includes the waste thermal energy.

19. The method of claim 14, wherein the energy includes solar energy, and wherein the method further comprises:
receiving, by a parabolic reflector, the energy, wherein the energy is solar energy;
focusing, by the parabolic reflector, the solar energy towards the waveguide; and
converting the solar energy into the first thermal energy within the waveguide.

20. The method of claim 14, wherein the substance is a flowing fluid connected to one or more components arranged in a district for cooling the one or more components by circulating the flowing fluid within the district; and wherein the method further 8 comprises:
receiving, at the waveguide, at least a portion of the flowing fluid from the district at a first temperature; and
lowering the first temperature or at least a portion of the flowing fluid to a second temperature.
